(19) United States
(12) Patent Application Publication
(10) Pub. No.: US 2012/0253992 A1
(43) Pub. Date: Oct. 4, 2012

(54) SYSTEMS AND METHODS FOR INVENTORY GENERATION AND MANAGEMENT

(75) Inventors: Ryan Melcher, Ben Lomond, CA (US); Steve Yankovich, San Jose, CA (US); Vincent Villanueva, Union City, CA (US); Mohan Patt, Hayward, CA (US); Jennifer Chang, San Francisco, CA (US); Enoch Chen, San Jose, CA (US); Danny Chang, Los Altos, CA (US)

(73) Assignee: eBay Inc., San Jose, CA (US)

(21) Appl. No.: 13/074,520

(22) Filed: Mar. 29, 2011

(51) Int. Cl. G06Q 30/00; G06Q 10/00

(52) U.S. Cl. 705/27.2; 705/28

(57) ABSTRACT

A method and a system to generate and manage an inventory are provided. The system may include a memory to store an inventory having a list of items owned by a consumer. An identification module may add an item to the inventory. A collection module may collect additional data about the added item. A tracking module may collect market data about the added item.

### TECHNICAL FIELD

The present application relates generally to the technical field of data processing and, in one specific example, to systems and methods for inventory generation and management.

### BACKGROUND

Consumers and their family members possess various goods for personal use. In some circumstances, a consumer may maintain an inventory of these goods.

### BRIEF DESCRIPTION OF THE DRAWINGS

Some embodiments are illustrated by way of example and not limitation in the figures of the accompanying drawings in which:

FIG. 1 is a network diagram depicting a client-server system, within which one example embodiment may be deployed.

FIG. 2 is a block diagram of an inventory system according to at least one embodiment.

FIG. 3 is a flowchart of a process for generating and managing an inventory according to at least one embodiment.

FIG. 4 is a high-level entity-relationship diagram, illustrating various tables that may be maintained within the databases, and that are utilized by and support the inventory system according to at least one embodiment.

FIG. 5 depicts a portion of an example user interface generated by the inventory system.

FIG. 6 shows a diagrammatic representation of a machine in the example form of a computer system within which a set of instructions for causing the machine to perform any one or more of the methodologies discussed herein may be executed.

### DETAILED DESCRIPTION

Example methods and systems to generate and mange an inventory are described. In the following description, for purposes of explanation, numerous specific details are set forth in order to provide a thorough understanding of example embodiments. It will be evident, however, to one skilled in the art that the present invention may be practiced without these specific details.

An inventory system is to generate and maintain an inventory of a consumer's belongings, including, for example, fungible products and collectibles. The inventory may include a list of items, a description of at least a portion of the respective items belonging to the consumer, a quantity of each item owned by the consumer, and a market value of each item. The inventory, as used herein, is defined as a list of items and associated description of the items that a particular consumer or set of consumers possesses. The inventory may include at least a partial description of at least a portion of the items. The inventory may be augmented with market data for certain items. The consumers may include users of the inventory system, people identified by the user, or business entities.

The inventory system may establish an inventory account for the consumer. In some instances, the inventory account may be subdivided into multiple accounts or be associated with other accounts belonging to other consumers. Items may be added to the inventory account based on, for example, transactions associated with the consumer, input received from the consumer, or by other operations.

Upon receiving at least a partial identification of an item, the inventory system may collect additional item data from a plurality of sources, including the consumer, and update an item description. In the case of the item being a fungible good, the item in the inventory may be updated based on catalogue data associated with the fungible good.

The inventory system may collect market data for the respective items in the inventory. The market data may include a current market value for an item in inventory based on recent transactions, availability notes, or information about events that may affect the value of the item. The market data, along with a description of the item, may be displayed to the consumer via a user interface.

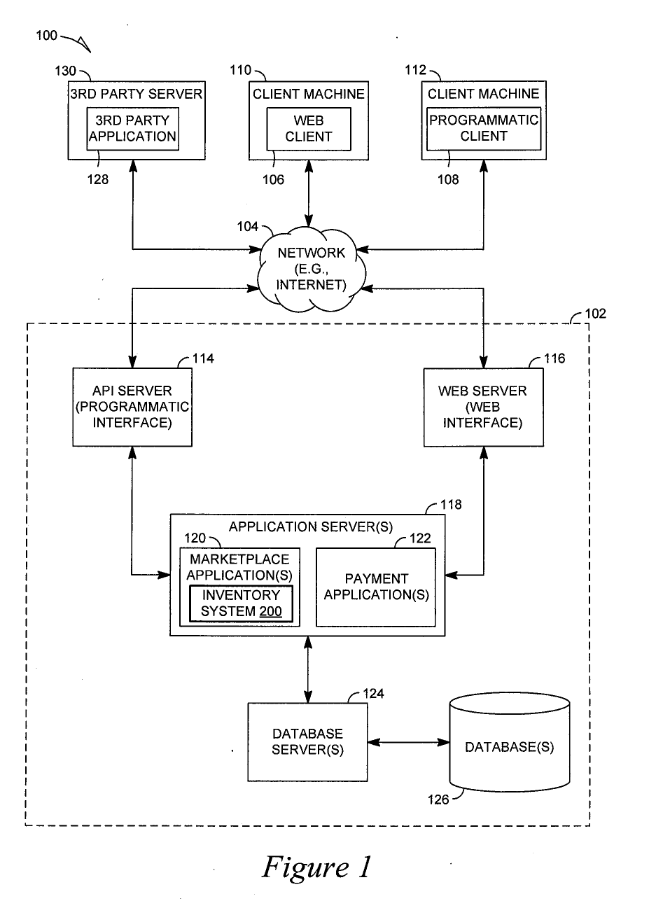

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users that access the networked system 102 and may include an inventory system 200. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, embodiments are not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more promotional, marketplace or payment functions that are supported by the relevant applications of the networked system 102.

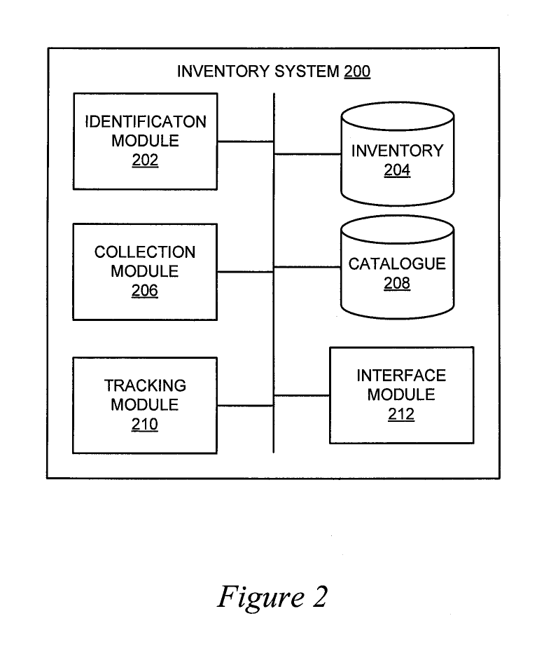

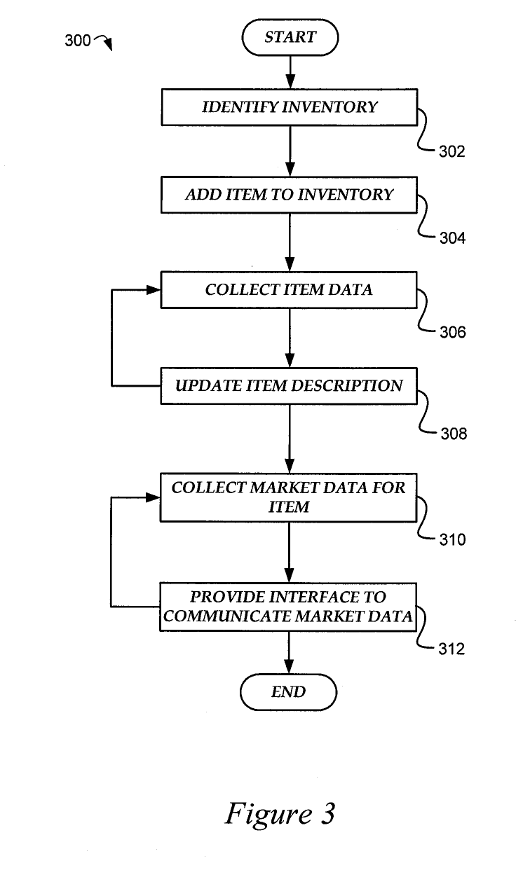

FIG. 2 is a block diagram of an inventory system 200 according to at least one embodiment. The inventory system 200 may be implemented in hardware, software, or a combination thereof. The inventory system 200 is configured to generate an inventory and maintain the inventory for a number of consumers. For simplicity, the inventory system 200 is described as generating a single inventory for a single consumer. It is understood that the inventory system may generate and maintain multiple inventories for multiple consumers. The identification of a particular inventory is discussed in greater detail in connection with FIG. 3.

Upon receiving an identification of a particular inventory maintained by the inventory system 200, an identification module 202 is configured to receive an indication that the consumer possesses or owns a particular item. The indication may be a record that the consumer has purchased the item using the marketplace application 120, a universal product code (UPC) input (or other bar code) from a camera or optical scanner, a selection of the item by the consumer via a user interface, a picture of the item received from the consumer, text received from the consumer, or by other data collected about or by the consumer. In some embodiments, the consumer may scan a bar code printed on a receipt that identifies multiple items purchased by the consumer at a point of sale (POS) system in a store. Other identifiers, such as vehicle identification numbers (VINs) or serial numbers, may be provided by the consumer.

In some instances, search terms saved by the user or used repeatedly by the user may be identified and associated with a particular item owned by the consumer. For example, if the saved searches include various car parts for a 1987 Nissan truck, the identification module 202 may determine that the consumer owns a 1987 Nissan truck. In these instances, the identification module 202 may send a confirmation message to the consumer to confirm that the consumer does, in fact, own the 1987 Nissan truck.

The indication received by the identification module 202 may or may not include a complete description of the item. Upon receiving the indication, the identification module 202 stores the indication and as complete a description as known in an inventory 204. The inventory 204 stores and makes available the indications of the items of the consumer.

In some instances, the identification module 202 is further configured to manage a wish list associated with the consumer. The wish list includes at least a portion of a description of one or more items that the consumer desires to purchase (or have purchased for him) at some point in the future. The identification module 202 may access the inventory 204 to complete a description of an item on the wish list. For example, if the inventory 204 includes a description of a 1987 Nissan truck and the consumer has added “windshield wipers” to his wish list, the identification module 202 (or the collection module 204, discussed below), may include the windshield wipers on the wish list as being “windshield wipers for a 1987 Nissan truck.” In some instances, a product code or part number for appropriate windshield wipers may be determined and added to the wish list.

The collection module 206 is configured to collect additional details about an item and to confirm an identity of an item. The additional details about an item may be collected from multiple sources such as manufacturers, retailers, distributors, media sources, consumers, and experts. The item may be a fungible good identifiable by a UPC scanned by the consumer or may be a rare collectible identifiable by experts. To populate descriptions of particular items, particularly a fungible good, the collection module 206 may access a catalogue 208. The catalogue 208 may include at least one table that includes descriptions or specifications known about the fungible good. A fungible good in a particular inventory 204 may include a pointer to the catalogue 208. For rare items or items that are not included in the catalogue 208, the collection module 206 may store the additional details in the inventory 204. In instances where the consumer purchased the item using a marketplace application 120, the item description published by a seller during the sale of the item may be used to populate the description of the purchased item.

A tracking module 210 is configured to collect market data about the items in the inventory 204. The market data may be collected from one or more resources including transaction data in an online marketplace. Other sources of data include published pricelists, market data for similar items. The similar items may be complementary (e.g., accessories for a device) or competitive (e.g., replacements for an item).

An interface module 212 is to generate a user interface to display the inventory to the consumer. The user interface may include a description of the item accessed from the inventory and/or the catalogue 208 and market data pertaining to the item. The interface module 212 may assemble an interface for a set of inventories accessible to the consumer. In some embodiments, the interface module 212 may communicate with the marketplace applications 120 and the payment applications 122 to provide an option to list a particular item in the inventory for sale in an online marketplace.

In some embodiments, the inventory 204 maintained by the inventory system 200 may be used to provide search results. For example, a search module (not shown) among the marketplace applications 120 may access the inventory 204 (or data about the consumer derived from the inventory 204) to refine search results provided to the consumer in response to a query. For example, if the inventory 204 associated with the consumer includes the 1987 Nissan truck and the consumer enters a query for “windshield wipers,” the search module may provide search results directed to windshield wipers for a 1987 Nissan truck. In some embodiments, search results related to a 1987 Nissan truck may be prioritized or featured within the search results provided to the consumer.

In further instances, the inventory 204 may be used to establish social groups of consumers who own similar items. For example, if a number of consumers each own a 1987 Nissan truck, a social group for 1987 Nissan truck owners may be created within a social network. Each consumer who owns a 1987 Nissan truck may be invited to join the social group. The social network may provide a number of features to the members of the social group. These features may include a wall, a forum having a number of chat rooms, profile pages for each member where the member may post images of his 1987 Nissan truck, a buy/sell feature where the member may list 1987 Nissan trucks and related items (e.g., spare parts) for sale.

FIG. 3 is a flowchart of a process 300 for generating and managing a particular inventory in the inventory 204 according to at least one embodiment. The process 300 may at least partially be performed by the inventory system 200.

In an operation 302, the particular inventory within the inventory 204 is identified. The particular inventory may be accessible by one or more consumers. The particular inventory may comprise a set of two or more inventories or be linked to other inventories. For example, the particular inventory may be a family inventory having items divided by family members, for example, a father, a mother, and a child. In other instances, the family inventory may be constructed as a set of linked inventories having permissions. For example, a mother may be able to access a father's inventory and a child's inventory but the child may not have access to his parent's inventories. The permissions may define the ability of a consumer within the family to perform certain tasks such as adding items to an inventory and listing items for sale. For example, a father may be able to list items in the child's inventory for sale but not the mother's items even though the mother's items are visible to the father.

In an operation 304, at least one item is added to an inventory. The addition of the item may be performed as described above in connection with the collection module 206. The item may have a full or partial description at the time it is added.

In an operation 306, data about the added item may be collected from one or more sources. In an operation 308, the collected data is added to the item description by storing the information in the inventory 204 or the catalogue 208. Operations 306 and 308 may be repeated as additional information is collected.

In an operation 310, market data is collected for the item, and in an operation 312 an interface is provided to communicate the market data to the consumer. The operation 310 may be performed upon receiving a request for the interface of operation 312 or may be performed at other times. For fungible goods that may be included in more than one inventory, the market data may be collected continuously or periodically.

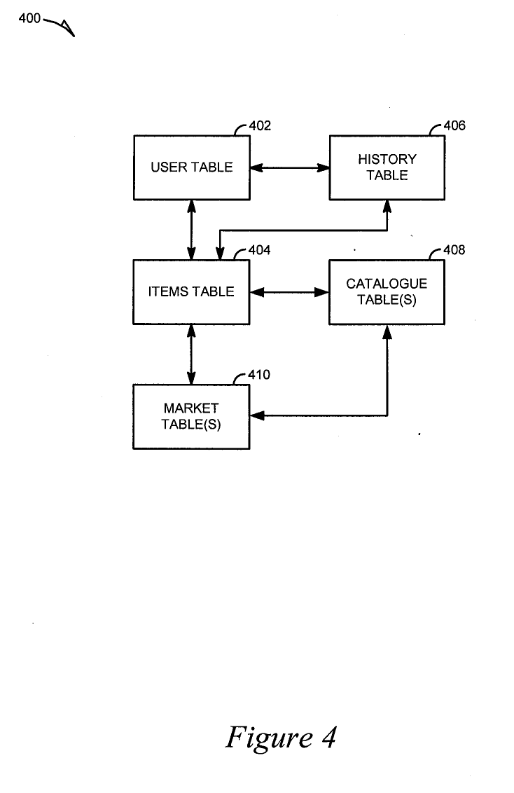

FIG. 4 is a high-level entity-relationship diagram, illustrating various tables 400 that may be maintained within the inventory 204 and the catalogue 208, and that are utilized by and support the inventory system 200. A user table 402 contains a record for each registered consumer of the networked system 102, and may include identifier, address and financial instrument information pertaining to each such registered consumer. A consumer may operate as a seller, a buyer, or both, within the networked system 102. In one example embodiment, a buyer may be a consumer that has accumulated value (e.g., commercial or proprietary currency), and is accordingly able to exchange the accumulated value for items that are offered for sale by the networked system 102.

The tables 400 also include an items table 404 in which are maintained item records for items in an inventory associated with a consumer. Each record within the items table 404 may furthermore be linked to one or more consumer records within the user table 402, so as to associate a consumer with each item record.

A history table 406 maintains a history of transactions to which a consumer has been a party and may be used to identify items possessed by the consumer to be included in the inventory. Catalogue table 408 records information pertaining to the respective fungible goods for which records exist within the items table 404. Considering only a single example of information that may be stored in the catalogue table 408 for a particular item, a UPC attribute may record the UPC associated with the item. A market table 410 may record market information relating to an item in the items table 404.

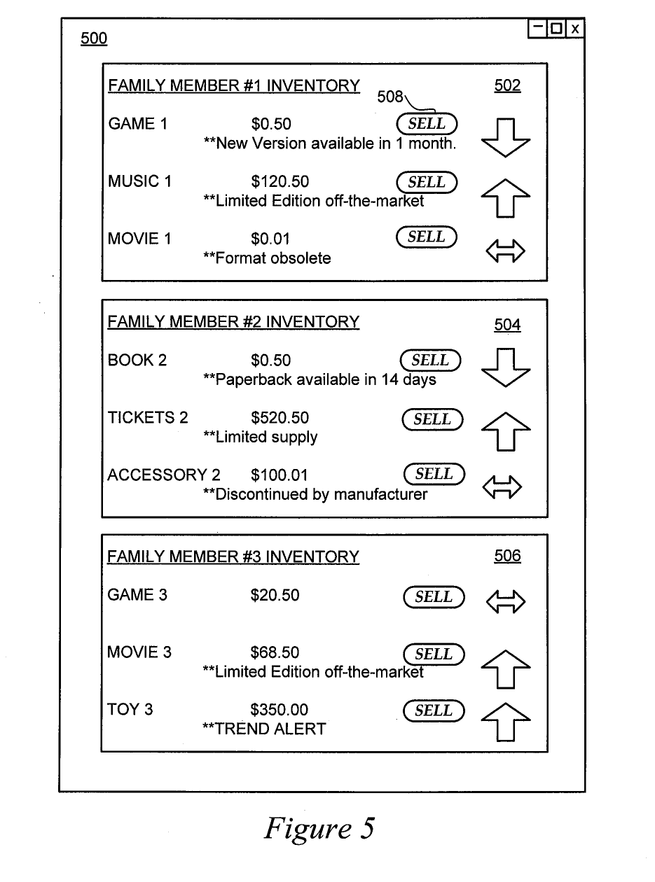

FIG. 5 depicts a portion of an example user interface 500 generated by the inventory system 200. The user interface 500 comprises three example inventories labeled “Family Member #1 Inventory” 502, “Family Member #2 Inventory” 504, and “Family Member #3 Inventory” 506, respectively. For each inventory, a number of short item titles are depicted (e.g., in “Family Member #1 Inventory” 502, “Game 1,” “Music 1,” and “Movie 1” are shown). The inventory may include longer item descriptions, images, or may link to more detailed information.

For the respective items listed in the inventory, the interface 500 includes market data including an expected resale value. The expected resale value may be based on recent sales and may be calculated as, for example, an average, median, or mode of recent sale prices. A price trend may be indicated to the user graphically, for example by arrows pointing up, down, and sideways. Other graphics may include graphs, charts, or the like. Notations explaining reasons for price trends may be included in the interface 500. The interface 500 may include an option to sell 508 the item in the inventory. Upon selecting the option to sell 508, the item may be listed for sale by the marketplace applications 120.

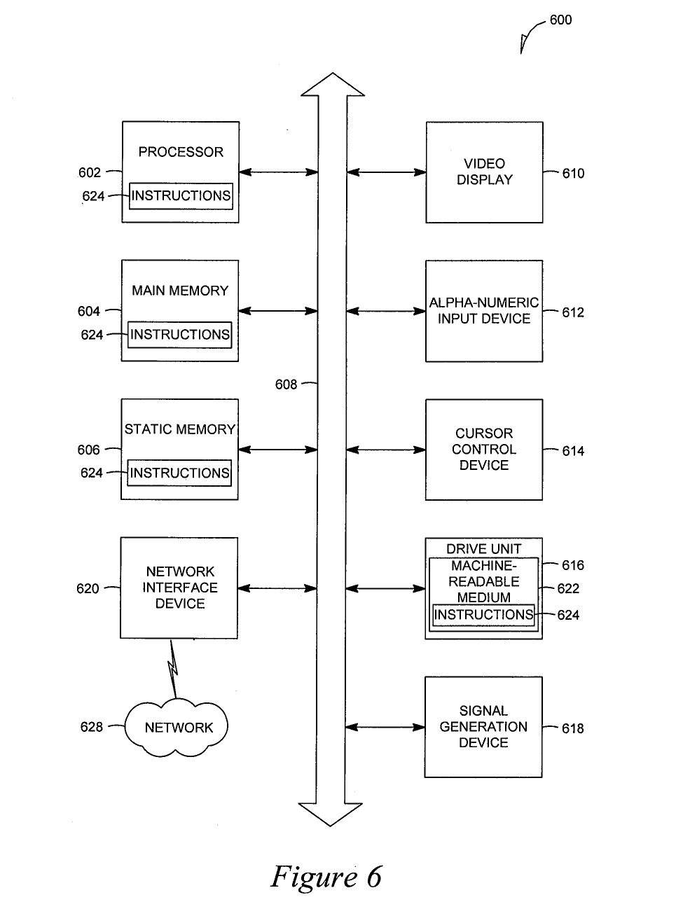

FIG. 6 shows a diagrammatic representation of a machine in the example form of a computer system 600 within which a set of instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU) a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker) and a network interface device 620. The computer system 600 may include a touchscreen (not shown).

The disk drive unit 616 includes a machine-readable medium 622 on which is stored one or more sets of instructions 624 (e.g., software) embodying any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media.

The instructions 624 may further be transmitted or received over a network 628 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system to generate and manage inventories have been described. Some embodiments may be used to provide a technical solution to a technical problem of populating records accurately and efficiently to minimize errors caused by user error. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
a memory to store an inventory corresponding to a consumer, the inventory comprising a list of items; and
a processor to execute:
an identification module to add an item to the inventory;
a collection module to collect additional data about the added item; and
a tracking module to collect market data about the added item.

2. The system of claim 1, wherein the processor is further to execute an interface module to generate an interface to display the inventory and the market data about the added item.

3. The system of claim 2, wherein the interface module is further to provide an option, within the interface, to list the item for sale in an online marketplace.

4. The system of claim 1, further comprising another memory to store a catalogue, the catalogue including information about a fungible good included in the inventory.

5. The system of claim 4, wherein the collection module is to access the other memory to retrieve data about the added item.

6. The system of claim 1, wherein the inventory includes a description of the item.

7. The system of claim 1, wherein the identification module is to add the added item based on a purchase of the item by the consumer.

8. The system of claim 1, wherein the identification module is to add the added item based on a universal product code received from the consumer.

9. The system of claim 1, wherein the identification module is to add the added item based on a picture received from the consumer.

10. The system of claim 1, wherein the tracking module is to collect market data including sale prices for other instances of the item.

11. The system of claim 1, wherein the tracking module is to collect market data including market data about similar items.

12. The system of claim 1, wherein the inventory is a family inventory.

13. The system of claim 12, wherein the family inventory includes permissions to view an inventory of another family member.

14. The system of claim 12, wherein the family inventory includes permissions to list the added item for sale by another family member.

15. A method comprising:
identifying an inventory corresponding to a consumer, the inventory comprising a list of items;
adding an item to the inventory;
collecting additional data about the added item;
collecting market data about the added item; and
providing an interface to display the inventory and the market data to the consumer.

16. The method of claim 15, further comprising providing an option to the consumer to list the item for sale in an online marketplace within the interface.

17. The method of claim 15, wherein the collecting of the market data comprises accessing a catalogue, the catalogue including information about a fungible good included in the inventory.

18. The method of claim 15, wherein the inventory is a family inventory.

19. The method of claim 18, wherein the family inventory is associated with permissions to list the added item for sale by another family member.

20. A non-transitory computer-readable medium having instructions embodied thereon, the instructions executable by a processor to perform a method to provide an inventory, the method comprising:
identifying an inventory corresponding to a consumer, the inventory comprising a list of items;
adding an item to the inventory;
collecting additional data about the added item;
collecting market data about the added item; and
providing an interface to display the inventory and the market data to the consumer.
